(19) United States
(12) Patent Application Publication
(10) Pub. No.: US 2004/0248583 A1
(43) Pub. Date: Dec. 9, 2004

(54) Resource allocation in cellular telephone networks

(76) Inventors: Aharon Satt, Haifa (IL); Liron Langer, Haifa (IL)

Correspondence Address: POLSINELLI SHALTON WELTE SUELTHAUS P.C., 700 W. 47TH STREET, SUITE 1000, KANSAS CITY, MO, 64112-1802, US

(21) Appl. No.: 10/500,052

(22) PCT Filed: Dec. 27, 2001
(86) PCT No.: PCT/GB01/05784

Related U.S. Application Data
(60) Provisional application No. 60/258,172, filed on Dec. 27, 2000.

(51) Int. Cl. H04Q 7/20

(52) U.S. Cl. 455/452.2; 455/433; 455/422.1

(57) ABSTRACT

A resource allocation system for a network, the system including a traffic shaper operative to decompose a network stream into a plurality of flows, each flow representing a service or application on a network down-link, and shape network traffic by allocating a different bandwidth and delay to each flow, and a policy processor operative to control the traffic shaper and dynamically allocate at least one air interface resource to at least one network device in association with at least one of the flows.

### FIELD OF THE INVENTION

The present invention relates to cellular telephony in general, and more particularly to resource allocation therefor.

### BACKGROUND OF THE INVENTION

The mobile telecommunications market is undergoing revolutionary changes worldwide. Many mobile operators worldwide, have already selected GPRS vendors and started implementing GPRS-based mobile data service. Initially, the following applications are expected to appear:

Entertainment applications including downloadable data and interactive gaming, based on rich media—text, graphics and audio/video streaming

Personal messaging including of text, graphics and audio/video streaming

E-mail

Personal information services (ticketing, whether, sports, healthcare, etc.)

M-commerce

Location-based services

These services differ in real-time priorities and bandwidth requirements. Interactive entertainment applications, M-commerce, and to some extent location-based services, are more sensitive to delay than some of the other applications. Audio/video streaming require stable bandwidth allocation to ensure playback quality.

The air interface resources available for these services are limited. In the GPRS system in particular, voice and data share the same scarce resources within each cell. The diversity of new data applications will only raise the demand for bandwidth.

FIG. 1 graphically illustrates the rapid fall in the transmission quality once the required usage of the users within a given cell exceeds the cell's capacity. Under over-utilization conditions, the delay increases quickly, packets are erased, and the service quality deteriorates below an accepted level.

Resource management systems exist for IP data networks, such as corporate Intranets and ISP networks. Unfortunately, such systems do not provide solutions for mobile network resource management problems, as current systems prioritize different application flows based on the application type and source/destination 1P addresses. These systems cannot manage a “budget” per cell, as they are not aware of the load on each cell. As a result, service quality cannot be guaranteed. For example, video streaming may be prioritized over e-mail, but the amount of concurrent video streams sent over the air interface of a certain cell cannot be limited. Once a certain type of flow overloads the air-interface, the service level of all users falls rapidly.

In order to ensure an acceptable level of quality, there is a clear need to provide the required resources for each application.

### SUMMARY OF THE INVENTION

The present invention provides for resource allocation in cellular telephone networks that overcomes disadvantages of the prior art. This is accomplished by:

Careful dynamic management of bandwidth allocation that supports the different delay/bandwidth requirements and priorities of various applications and ensures service quality while mobile users are moving across different cells;

Allocating resources dynamically based on the available changing capacity for data applications within each cell while avoiding over-allocation to enable consistent service quality.

The present invention provides “virtual circuits” for certain application flows over the connection-less GPRS data network, and in particular over the limited air-interface.

The present invention improves on the prior art in one or more of the following ways:

Provides consistent service quality to delay/bandwidth-sensitive applications, including real-time multimedia streaming, M-commerce, and other applications.

Increases the traffic over a given air interface at a consistent service level, via efficient utilization of the air interface capacity. This results in lower capital expenses.

Supports service level differentiation, thereby providing an additional revenue source.

Provides real-time statistical information concerning the network load and service quality in support of efficient network planning and maintenance.

Enables application screening, such as is required for push services. The commercial success of push services depends on effective filtering of undesired content push in order to avoid unaware usage of air interface resources and to extend mobile battery life. The policy management mechanism may be equally utilized for filtering out application flows, based on personalized policy that the end-user may control.

The disclosures of all patents, patent applications, and other publications mentioned in this specification and of the patents, patent applications, and other publications cited therein are hereby incorporated by reference in their entirety.

### BRIEF DESCRIPTION OF THE DRAWINGS

The present invention will be understood and appreciated more fully from the following detailed description taken in conjunction with the appended drawings in which:

FIG. 1 is a simplified graphical illustration showing the relationship between transmission quality and cell capacity, useful in understanding the present invention;

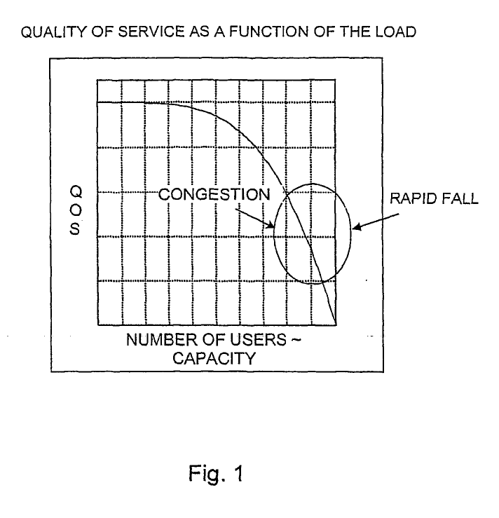

FIG. 2 is a graphical illustration of the statistical behavior of voice calls versus data sessions, useful in understanding the present invention;

FIG. 3 is a simplified block diagram of a resource allocation system, constructed and operative in accordance with a preferred embodiment of the present invention;

FIG. 4 is a simplified block diagram a system of data flow and signaling control, constructed and operative in accordance with a preferred embodiment of the present invention;

FIG. 5, is a simplified block diagram of a topology of a resource allocation system, constructed and operative in accordance with a preferred embodiment of the present invention;

FIG. 6 is a simplified block diagram of the interaction of a traffic shaper and a WAP gateway, constructed and operative in accordance with a preferred embodiment of the present invention;

FIG. 7 is a simplified block diagram of the interaction of a traffic shaper and a WAP gateway/NAT, constructed and operative in accordance with a preferred embodiment of the present invention;

FIG. 8 is a simplified block diagram of the interaction of a traffic shaper and a WAP gateway, constructed and operative in accordance with a preferred embodiment of the present invention;

FIG. 9 is a simplified block diagram of a policy processor architecture, constructed and operative in accordance with a preferred embodiment of the present invention;

FIG. 10 is a simplified block diagram of a Gb analyzer, constructed and operative in accordance with a preferred embodiment of the present invention;

FIG. 11 is a simplified block diagram of a core engine and main logic, constructed and operative in accordance with a preferred embodiment of the present invention;

FIG. 12 is a simplified graphical illustration of a cell tracking mechanism, operative in accordance with a preferred embodiment of the present invention;

FIG. 13 is a simplified block diagram of an SMS gateway, constructed and operative in accordance with a preferred embodiment of the present invention;

FIG. 14 is a simplified block diagram of a simulation of resource allocation operative in accordance with a preferred embodiment of the present invention;

FIG. 15 is a simplified block diagram of a data traffic generator, constructed and operative in accordance with a preferred embodiment of the present invention;

FIG. 16 is a simplified block diagram of a single-user data traffic generator model, constructed and operative in accordance with a preferred embodiment of the present invention; and

FIG. 17 is a simplified block diagram of uplink data flow control, constructed and operative in accordance with a preferred embodiment of the present invention.

### DETAILED DESCRIPTION OF PREFERRED EMBODIMENTS

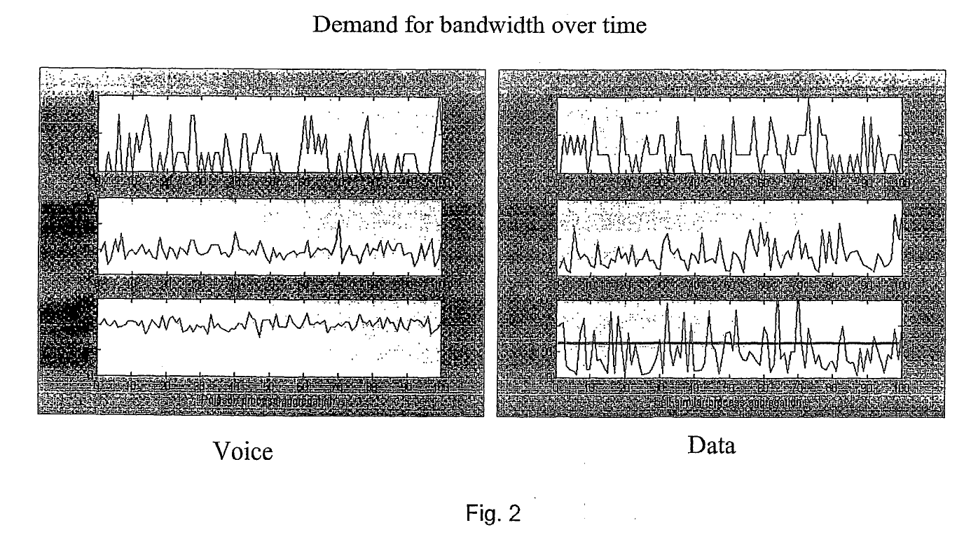

Reference is now made to FIG. 2, which is a graphical illustration of the statistical behavior of voice calls versus data sessions, useful in understanding the present invention. In voice transmissions the demand for bandwidth tends to be constant as more voice calls are aggregated. In contrast, data transmissions tend to exhibit burstiness even when aggregated. The present invention exploits this behavior and dynamically “flattens” the demand for bit rate, thereby enabling higher utilization of the limited bandwidth resources.

The “flattening” principle is implemented as follows:

The dynamic resource allocation for each application packet flow is made to depend on its tolerance to delay and requirement for bandwidth.

At peak demand, the less delay-sensitive flows are delayed, providing resources for time-critical applications.

This results in smoother demand for bandwidth with lower peaks, where the same amount of traffic is delivered over less air interface channels, while still supporting the required service quality level.

Resources are also allocated according to the given capacity. For example, where up to 8 simultaneous video streams may be supported concurrently within a given cell (video stream requires certain minimum bit rate to guarantee image quality), the 9th user will not get resource allocation for an additional video stream until enough resources are available, thereby guaranteeing consistent quality level for the existing 8 video users. In another example, in an interactive mobile E-commerce transaction a certain average bit rate is required to guarantee an average system response delay to user requests. Assuming that the bandwidth allocated for a given transaction on a given cell supports up to 20 concurrent E-commerce sessions simultaneously, where additional sessions may cause the average system response delay to be unacceptably high, then all users above the current 20 will not be allowed to proceed with E-commerce transactions until enough bandwidth resources are freed. When a service is currently unavailable due to limited bandwidth or other resources, then the mobile user may receive a system message indicating that the service is temporarily unavailable.

The user mobility creates the need for dynamic resource management across cells in order to ensure a stable service level. During hand-off, the mobile user is “transferred” from one cell “budget” to another, such that the mobile user loses his resource allocation in one cell and receives a new resource allocation in the next cell. Where consistent resource allocation across cells is not supported, real-time applications such as video applications will suffer from degradation of service.

In order to support maximum utilization of the scarce cell resources, the system allocates resources dynamically, based on relevant criteria for service level quality, including the following:

The mobile user QoS profile

The service provider (ASP) QoS profile

The application type (messaging, multimedia streaming, e-mail, M-commerce, etc.)

The mobile user location

The time and the date of the allocation request

The type and capabilities of the mobile handset or any other communication device used by the mobile user (e.g., PDAs and palmtop computers)

The capabilities of the information server at the service provider

Past usage profile (e.g., amount of data of a certain type per mobile user or per application service provider over a period of time)

The carrier policies

The dynamic data transport capacity within each cell.

The “mobile user” referred to herein may be identified in various ways, including a GSM identity such as MSISDN, a handset identity, a personal identification of the user, and other identities related to roaming. The resource allocation process may use any or all of these identities.

The present invention actively and dynamically manages the cell budget or sector budget, and provides support for virtual circuits that guarantees a level performance. The present invention is fully aware of mobile user locations, the allocated dynamic IP addresses to each mobile user, the user QoS attributes as saved in the HLR, and the mobile station capabilities. These parameters enable powerful policy management rules, based on the GSM user identity, the user location, and the carrier's policy in a trusted and secured manner.

While the present invention is described with specific reference to the GSM/GPRS system, it is applicable to any type of mobile data network. The present invention provides a network-wide overlay layer on top of existing mobile network infrastructure, which monitors data traffic, management signals, and other information sources at various points, and controls the flow of data through various locations. Furthermore, while the present invention relates to resource management over the air interface, it is applicable to resource management of any aspect of the mobile/cellular data network, including land network elements. In particular, the present invention may be applied to end-to-end resource management from any information point (e.g., the data server or any other information source or communication device on the IP side of the network, including the Internet), to the mobile station.

The present invention may be embodied as three cooperative elements:

A Traffic Shaper that decomposes the overall IP stream into services and applications on the down-link, expresses them as flows, and shapes the traffic by allocating different bandwidth and delay to each flow. The traffic shaper is controlled by the policy manager, or policy processor, which ensures the proper dynamic allocation of the air interface resources to the different applications and users.

A Policy Processor that interfaces with the mobile system infrastructure and retrieves information regarding the mobile user profile and location, the ASP profile, the load on the air-interface, and other information. Based on this information, the policy processor issues service quality control signals to the traffic shaper. The policy processor is preferably optimized for mobile data services, is connected to the relevant mobile network elements in a secured environment, and determines the resource allocation rules for bandwidth and delay according to the carrier's policy.

An Administration unit that provide a graphical means for an administrator to provision the service, define the policies, and monitor the system operations.

The present invention assumes passive monitoring, or probing, on the Gb interface and other interfaces for simplicity of integration into the carrier's network. The various elements of the present invention preferably perform passive probing on the Gb interface, the HLR and the Radius server. The IP side, or the Gi interface, is typically the only point where active traffic shaping is done.

The present invention may support active control and traffic shaping on one or more of the points of the data traffic on the network including monitored points (“active probing”). In particular, monitoring and controlling of air-interface resources may be done within the base stations and the cell transceiver locations.

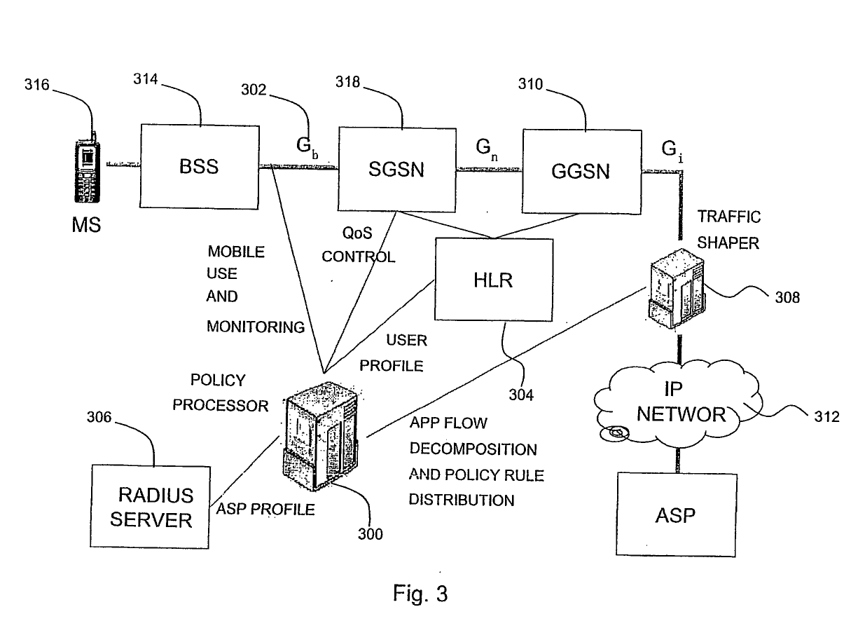

Reference is now made to FIG. 3, which is a simplified block diagram of a resource allocation system, constructed and operative in accordance with a preferred embodiment of the present invention. For illustration purposes only, FIG. 3 may be understood with the assumption that no hand-off takes place, i.e. the mobile user is constantly served by one cell, and that the mobile station opens one PDP context to access a single APN. In the system of FIG. 3 a policy processor 300 is shown including the following functionality:

A capacity and mobility analyzer which monitors a Gb interface 302 in order to track the distribution of the mobile stations among the cells, and to determine the load and available resources over the air interface. Using the mobility management and flow control messages of the BSSGP protocol that pass over Gb interface 302 from a BSS 314 to an SGSN 318, policy processor 300 is capable of tracking the location of a mobile station (MS) 316, the status of the open PDP contexts, and the free air interface resources.

A core policy processor responsible for the overall budget management, per cell, in terms of bit rate, delay, duration and amount of data. The policy rules are determined such that the overall bit rate that is transmitted to each cell on the down-link does not exceed the dynamic capacity which is available for data transmission in the cell. The policy is also dependent on the mobile user profile (such as may be stored in an HLR 304 or any other database including VLRs), the ASP QoS profile (such as may be stored in a Radius server 306), and the handset capabilities.

A policy provisioning unit including a graphical user interface that may be used by a system administrator to determine the carrier's policies and monitor the system performance. The monitoring may include message and error logging, statistics collection (e.g., of traffic, load, resource usage, etc.) and call/session data record storage. The data gathered by the monitoring unit may form the basis for network planning and tuning.

A traffic shaper 308 is also shown connected over the IP link between a GGSN 310 and an IP packet network 312. It decomposes the down-link IP stream into flows, where each flow relates to a specific source, destination, and application. The traffic shaper enforces the policy over each flow based on given policy rules, in terms of average and peak bit rate, delay, duration and the amount of data to be transmitted. The policy rules are preferably determined by a policy manager and updated in real-time to handle dynamic load changes in each cell.

Policy processor 300 may be connected to SGSN 318 in order to control the QoS attributes in real time. Such an interface is not currently implemented in commercial SGSNs, although it is defined in the GPRS specification. Therefore, traffic shaper 308 alone may be used to enforce the policy rules.

Policy processor 300 is preferably implemented as a distributed server, having one policy processor per SGSN and a centralized policy-provisioning unit. This implementation is designed to handle the mobility and the hand-off across cells and between SGSNs, handle several down-link streams from several GGSNs to one mobile station, and support scalability.

The system of FIG. 3 may be applied to 3G (UMTS) systems in which only the control interfaces are different, e.g. IPv6 that supports QoS control via the TOS bit field. The cell resource monitoring, the real-time policy enforcement and the support for stable service level while moving, may be applied as is to enable delay/bandwidth-sensitive applications.

The system of FIG. 3 may be applied to any network element through which data traffic flows and may be used as traffic shaper. In particular, the data switch (SGSN 318), the gateway (GGSN 310), the based station elements and the radio equipment may implement traffic shaping. Policy processor 300 and other elements of our solution may be embedded within other network elements such as SGSN 318 and GGSN 310.

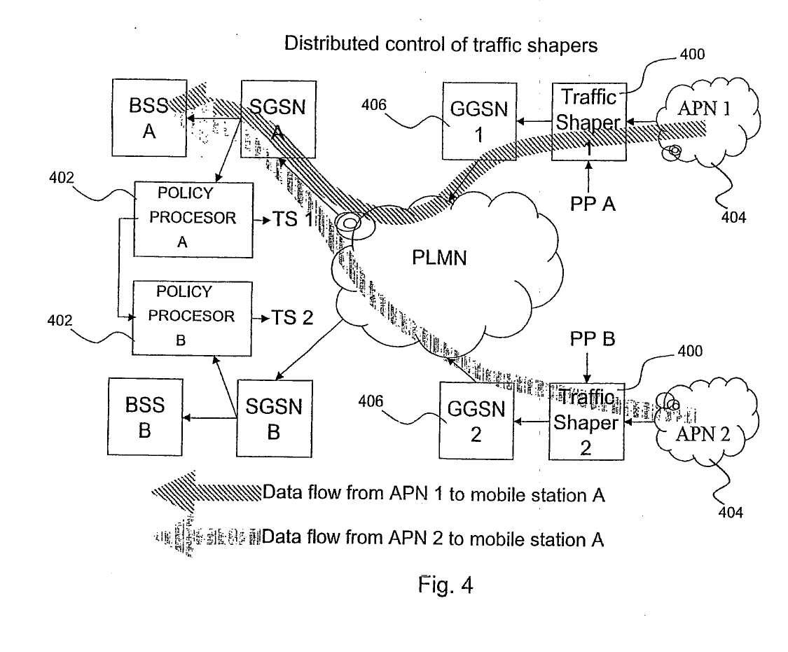

Reference is now made to FIG. 4, which is a simplified block diagram a system of data flow and signaling control, constructed and operative in accordance with a preferred embodiment of the present invention. FIG. 4 shows the data flow from several traffic shapers 400 to mobile stations, and the control signaling between traffic shapers 400 and policy processors 402. Each mobile station may be connected to multiple APNs 404 simultaneously, optionally having a separate IP address per APN. Thus each mobile station may be served by more than a single gateway (GGSN 406) concurrently. Each traffic shaper 400 is also controlled by a single policy manager/processor 402. Therefore, a distributed control mechanism is necessary, as is now described.

When a mobile station opens PDP-context for certain IP network (APN), an IP address is allocated to it, and a serving GGSN 406 is determined. The GGSN 406 is connected to a certain known traffic shaper 400, which in turn is controlled by a certain known policy processor 402. The linkage between APN 404 to traffic shaper 400, and between traffic shaper 400 to GGSN 406, is typically static and depends on the network topology. As is shown in FIG. 4, policy processor A, which serves a mobile station in base station A with IP address A over the 1P network APN 1, controls the traffic shaper 1 on APN 1. In this case, the policy processor A analyzes the Gb interface of base station A and issues control signaling for traffic shaper 1 which shapes the downlink flows of IP address A from APN 1 to the mobile station. The same mobile station is also connected to the IP network APN 2, where traffic shaper 2 is located. The policy processor A analyzes the Gb interface of base station A, and as a result it issues control signals for the traffic shaper 2 that shapes the downlink flows of IP address A from APN 2 to the mobile station. The control signals for traffic shaper 2 pass through policy processor B, which is directly connected to traffic shaper 2. Policy processor 2 serves as a “tunnel” for policy processor 1 to control the downlink flows of IP address A.

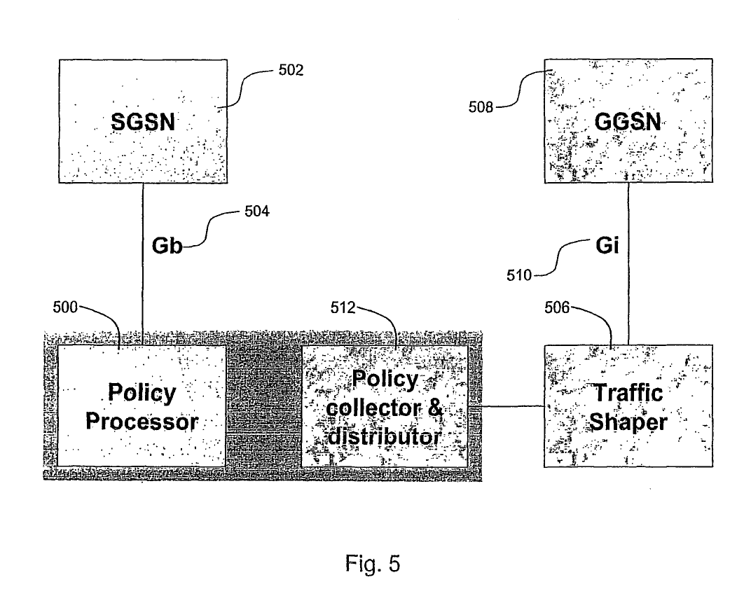

Reference is now made to FIG. 5, which is a simplified block diagram of a topology of a resource allocation system, constructed and operative in accordance with a preferred embodiment of the present invention. FIG. 5 shows the considerations for the physical location of the functional entities of the resource allocation system of the present invention. A policy processor 500 scales up linearly according to the number of SGSNs 502, as the complexity of policy processor 500 depends on the number of messages per unit of time over a Gb interface 504, which in turn depends on the size of SGSN 502. Therefore, one policy processor 500 may be implemented per SGSN 502, and preferably located near each SGSN 502 for efficient connection to Gb interface 504. The size of policy processor 500 in terms of computational capability/capacity depends on the size of SGSN 502.

A traffic shaper 506 scales up linearly according to the number of GGSNs 508, as the traffic shaper complexity depends on the IP traffic intensity over a Gi interface 510, which in turn depends on the size of GGSN 508. Therefore, one traffic shaper 506 may be implemented per GGSN 508, and preferably located near each GGSN 508 for efficient connection to Gi interface 510. The size of traffic shaper 506 in terms of computational capability/capacity depends on the size of GGSN 508.

The traffic shaper control interfaces (using COPS or equivalent protocols) are generally not suitable for the distributed architecture of the present invention. A typical traffic shaper may be controlled by a single policy processor at a time. A new entity, a policy collector and distributor 512, is provided to support multiple connections between each traffic shaper 506 and multiple policy processors 500. In order to limit the number of physical devices in the network, policy collector and distributor 512 may be implemented within policy processor 500.

To avoid a single point of failure, the following logic may be implemented. Each traffic shaper 506 logs on to a certain policy processor 500 that serves as its policy collector and distributor. This policy processor 500 is then responsible for updating the entire network on this connection (e.g., by broadcasting a message to the other policy processors). In case of any failure of policy processor 500, traffic shaper 506 logs on to another policy processor 500 which becomes its new policy collector and distributor. The latter policy processor updates the network of the connection change.

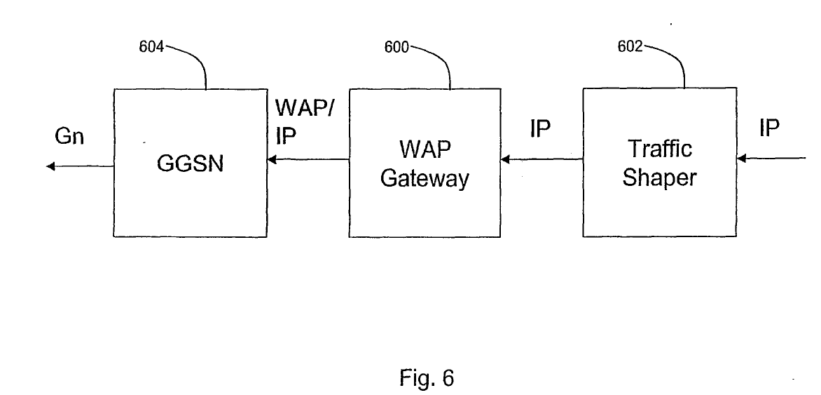

Reference is now made to FIG. 6, which is a simplified block diagram of the interaction of a traffic shaper and a WAP gateway, constructed and operative in accordance with a preferred embodiment of the present invention. The traffic shaper of the present invention may interact with other IP-side network elements such as:

WAP gateway

NAT (network address translator)

Encryption and VPN (virtual private network)

Data compression and TCP acceleration

In FIG. 6 a WAP gateway 600 intermediates between a traffic shaper 602 and a GGSN 604, translates HTTP/HTML protocols into XXX/WML, and optionally provides data compression and encryption services. The underlying IP protocol stack for WAP is still under standardization (currently, WAP uses replacements for IP and for TCP/UDP for circuit-switched data. This is not suitable for GPRS system, as the GGSN gateway is designed for IP. New WAP versions that preserve that IP and UDP/TCP protocol layers are now being standardized). A traffic shaper 602 is therefore shown connected on the pure IP side as it is designed for IP, TCP/UDP and HTTP protocol analysis.

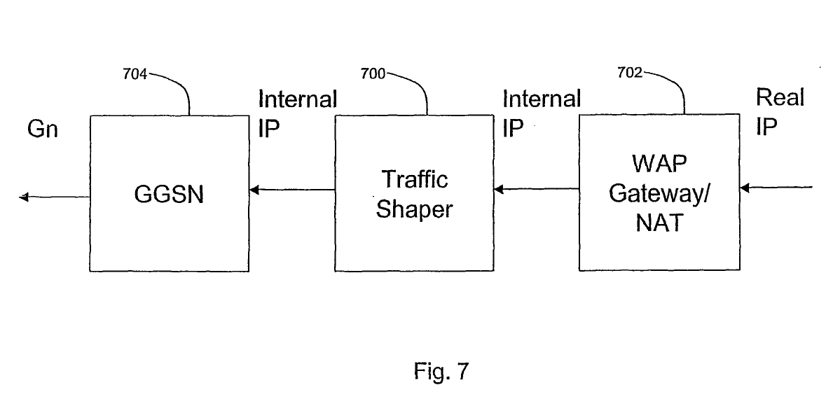

Reference is now made to FIG. 7, which is a simplified block diagram of the interaction of a traffic shaper and a WAP gateway/NAT, constructed and operative in accordance with a preferred embodiment of the present invention. In FIG. 7 a traffic shaper 700 intermediates between a WAP gateway/NAT 702 and a GGSN 704. NAT 702 provides IP address translation, particularly for mobile data networks, as the address space of IPv4 is not sufficient to support a unique allocation of a fixed IP address for each mobile station given all the other network elements on the Internet. To overcome this addressing limitation, each IP address may be shared by multiple mobile stations. This is achieved by allocating the IP addresses on a temporary and dynamic basis to mobile stations that are actively sending or receiving data. One way of implementing the NAT function is to include it within a WAP gateway as is shown in FIG. 7. On the mobile network side, each mobile station is allocated an IP address based on the internal address space of the mobile data network. On the IP network side, the internal IP address is translated to a real IP address on an as-needed basis. Thus, one real IP address may serve multiple mobile stations one at a time, provided that not all the mobile stations that are served by one WAP gateway are concurrently active. By locating the traffic shaper 700 between the NAT 702 and the GGSN 704 traffic shaper 700 may access internal IP addresses, which are IP addresses that attach to PDP contexts.

Other traffic shaper/WAP gateway implementations include:

Implementing the WAP gateway and the NAT separately, such that the traffic shaper is located between the WAP gateway and the NAT. Under this implementation, the traffic shaper “sees” the internal IP addresses as required for association with PDP contexts, while still shaping the IP-side traffic rather than the WAP-side.

Locating the traffic shaper between the WAP gateway and the GGSN. Thus, the traffic shaper is not capable of analyzing the higher-level protocol layers. The flow shaping is done based on IP addresses and TCP/UDP port numbers only.

Implementing an interface from the combined WAP gateway and NAT to the policy processor, which provides the IP translation table. Thus, the policy processor is capable of associating the internal IP addresses to real IP addresses in real time. Therefore, the traffic shaper may be located on the IP-side of the WAP-gateway and not on the WAP side, while “seeing” the internal IP addresses.

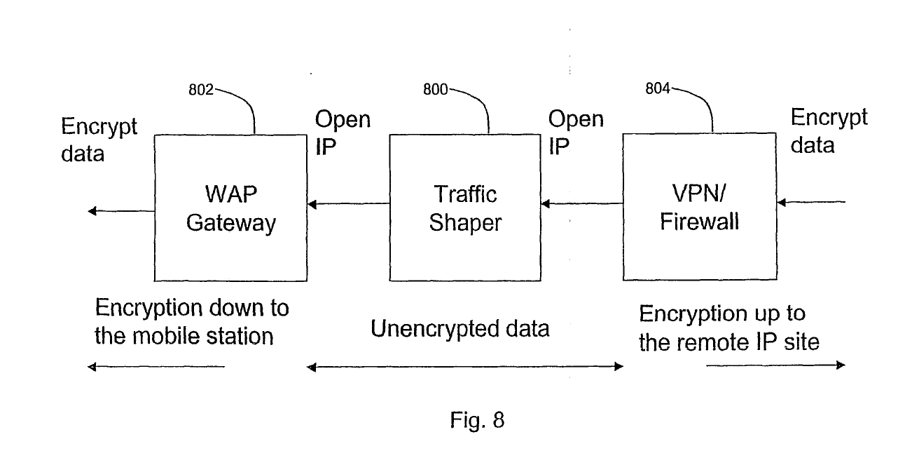

Reference is now made to FIG. 8, which is a simplified block diagram of the interaction of a traffic shaper and a WAP gateway, constructed and operative in accordance with a preferred embodiment of the present invention. In FIG. 8 a traffic shaper 800 intermediates between a WAP gateway 802 and a VPN/firewall 804. VPN 804 preferably provides an encrypted data tunnel to a remote IP site in order to support security over external/public networks. Typically, the encryption is combined with a firewall function. Additional encryption may be implemented by WAP gateway 802, creating a data tunnel to the mobile stations in order to support data security over the air interface. Traffic shaper 800 is preferably situated on the IP side (unencrypted side) relative to the WAP gateway 802, and on the mobile station side (unencrypted side) relative to the VPN/firewall 804.

TCP-acceleration/data-compression may also be used for optimizing data transmissions over the air interface as follows:

By compressing the data to reduce the traffic volume over the air interface. Alternatively, data compression may be performed by the WAP gateway.

By applying TCP acceleration to overcome the bit rate reduction of the TCP as a result of packet loss and delay over the air interface.

Both these function may be performed on a single application flow basis, in addition to or as an alternative to managing resource allocation based on the entire traffic on a cell. Where TCP-acceleration/data-compression changes the TCP format or the data, the location of the traffic shaper should be on the IP network side of the TCP-acceleration/data-compression element. However, where no changes occur to the TCP format or to the data, the location of the traffic shaper relative to the TCP-acceleration/data-compression element is not important.

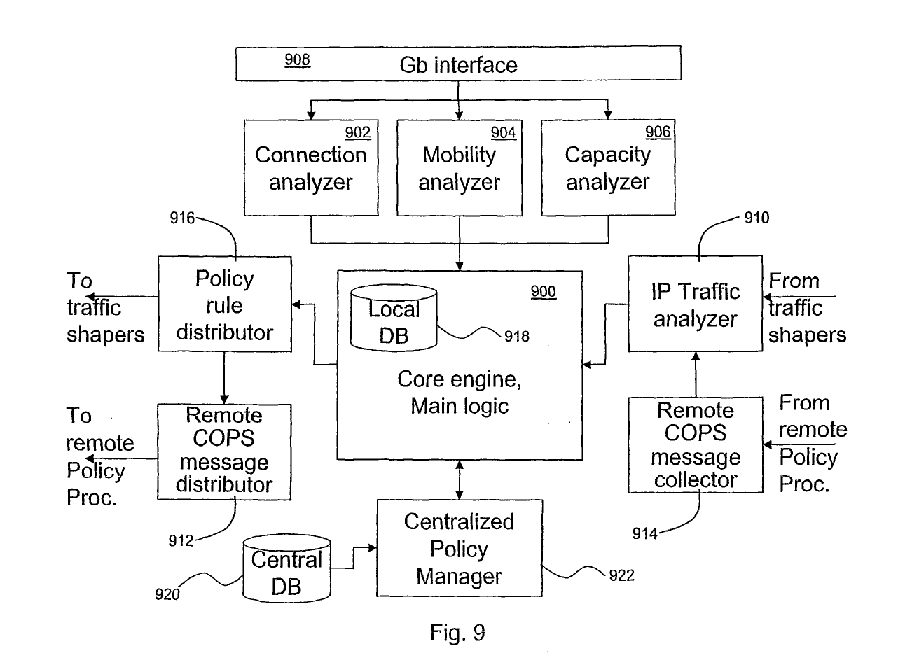

Reference is now made to FIG. 9, which is a simplified block diagram of a policy processor architecture, constructed and operative in accordance with a preferred embodiment of the present invention. In the architecture of FIG. 9 the policy processor consists of a core “engine” 900 which performs the main logic. Core engine 900 is connected to the network via analyzers and filters that translate formats of data and messages, and provide some auxiliary logic. Shown in FIG. 9 are Gb analyzers including a connection analyzer 902, a mobility analyzer 904, and a capacity analyzer 906, which analyze the data receiver over a Gb interface 908, and extract the relevant messages to determine certain parameters such as:

Parameters relating to mobile users, such as their location, expressed as the cell/sector that serves them, their PDP contexts, including IP addresses for the various APNs and the serving GGSNs, their hand-off and roaming messages, their handset identification and other capabilities

Parameters relating to the cell/sector load, based, among other messages, on flow control between the SGSN and the BSS/PCU.

The local policy processor is connected to one or more traffic shapers via two filters as follows:

An IP traffic analyzer 910 that extracts and analyzes the IP flow control messages received from the traffic shapers and that relate to local mobile users (i.e., mobile users across cells managed by the local policy processor). IP traffic analyzer 910 diverts messages that relate to remote mobile users to a remote COPS message distributor 912 which in turn sends them to remote policy processors that serve the remote mobile users. In addition, IP traffic analyzer 910 extracts and analyzes IP flow control messages for local mobile users received from remote policy processors via a remote COPS message collector 914.

A policy rule distributor 916 collates policy rule data and other messages received from the local policy processor and from remote policy processors via remote COPS message collector 914. The collated data is sent to the traffic shapers managed by the local policy processor.

The local policy processor is connected to remote policy processors via two filters as follows:

Remote COPS message collector 914 collects the messages from remote policy processors. These messages contain flow control data related to local mobile users and policy rules from remote policy processors to local traffic shapers. The flow control messages are analyzed by IP traffic analyzer 910. The policy rules are sent to traffic shapers by policy rule distributor 916.

Remote COPS message distributor 912 sends messages to remote policy processors. These messages flow control data for remote mobile users received from the local traffic shapers, and policy rules related to local mobile users for remote traffic shapers processed by remote policy processors.

A local database 918 is used for the following purposes:

Temporary storage of data objects processed by core engine 900

Repository for local QoS/User policy, as a cache for a central database 920

Repository for the network topology, such as which policy processor manages each traffic shaper

Temporary storage for call/session data records that created by core engine 900.

Reliability may be achieved by providing backup policy processors for the traffic shapers. Initially, when operation of the present invention begins, each traffic shaper logs on to its primary policy processor. After logging on, the policy processor manages the traffic shaper, collects all messages from remote policy processors to the traffic shaper, collates the messages and sends them to the traffic shaper. If the connection between the traffic shaper and its primary policy processor fails, e.g., no keep-alive signal is received, then the traffic shaper logs on to an alternate policy processor which then becomes the traffic shaper's new primary policy processor. It is the responsibility of the policy processor to notify the rest of the network that it has become the new primary policy processor for the traffic shaper. This may be done either through a centralized policy manager 922 or by directly notifying all other policy processors. The latter notification is believed to be more robust, in that it avoid any single point of failure.

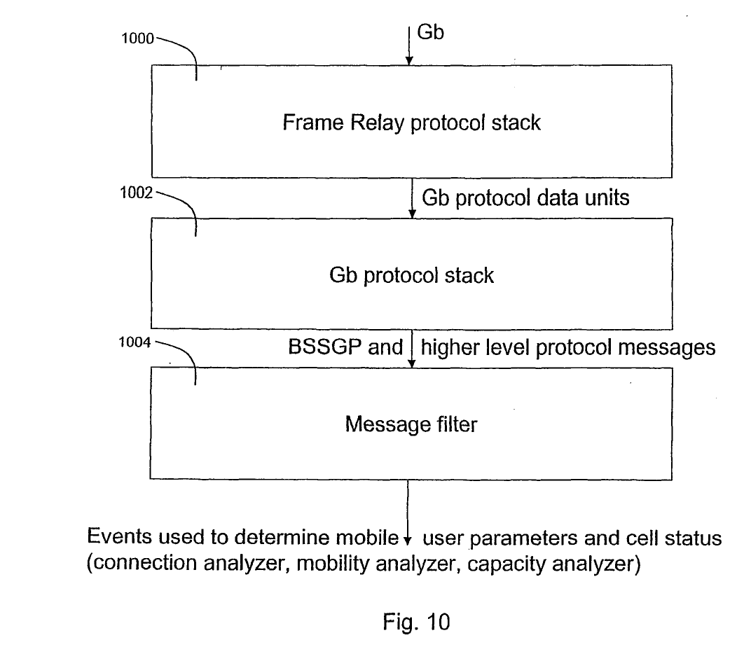

Reference is now made to FIG. 10, which is a simplified block diagram of a Gb analyzer, constructed and operative in accordance with a preferred embodiment of the present invention. The Gb analyzer of FIG. 10 is shown as having several layers, including a Frame relay protocol stack 1000 which provides Gb protocol data units to a Gb protocol stack 1002 which provides BSSGP and other higher level protocol messages to a message filter 1004.

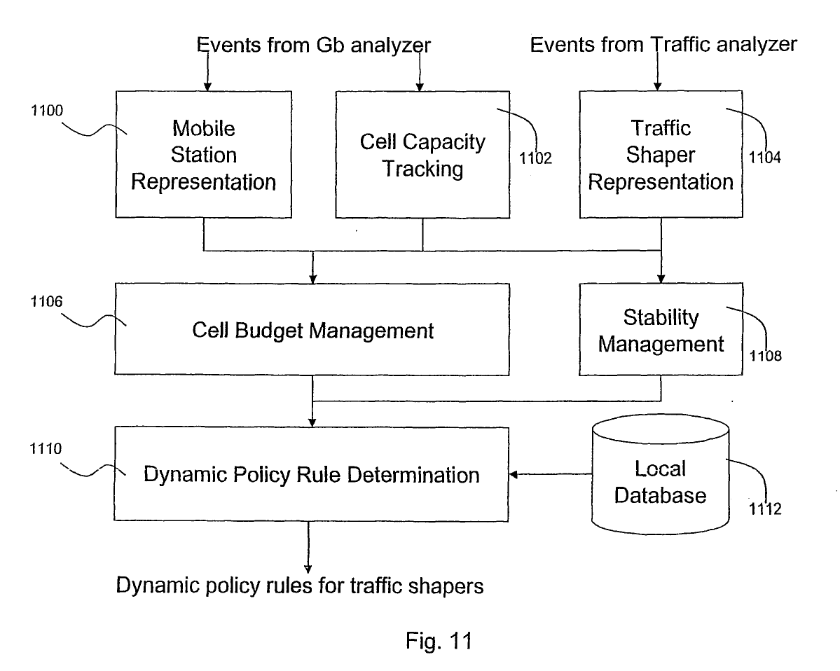

Reference is now made to FIG. 11, which is a simplified block diagram of a core engine and main logic, constructed and operative in accordance with a preferred embodiment of the present invention. In FIG. 11 the core engine performs event analysis and policy rule determination and includes a mobile station representation module 1100 that holds the objects that describe every active mobile station that is under the policy processor resource management. This description preferably includes the serving cell or sector identification, the mobile station addresses, handset capabilities, roaming and mobility information, the active PDP contexts, and other related information. A cell or sector capacity tracking module 1102 tracks the flow control messages over the BSSGP protocol, and extracts the messages needed for real-time tracking of the dynamically changing data capacity of the cell or sector. A traffic shaper representation module 1104 holds the objects that describe every traffic shaper that directly or indirectly serves the mobile stations under the local policy processor responsibility. “Directly” is preferably understood to mean direct connection to the traffic shaper, as opposed to indirect connection through a remote policy processor. The description includes the details of the application packet flows over the IP network, in particular in the downlink direction. These details include source and destination IP addresses, application type, usage in terms of time and amount of data, and other related information. Also shown in FIG. 11 are a cell budget management module 1106, a stability management module 1108, a dynamic policy rule determination module 1110 and a local database 1112.

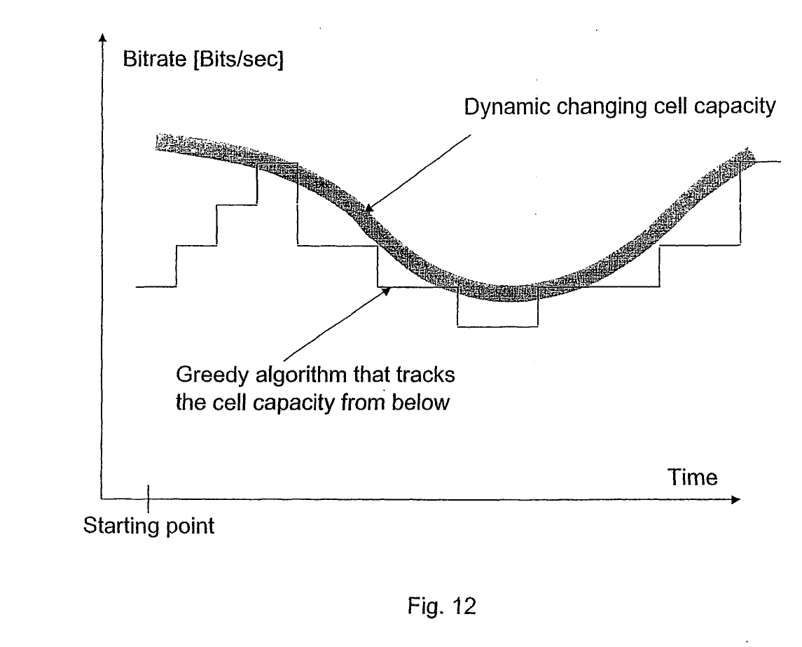

Reference is now made to FIG. 12, which is a simplified graphical illustration of a cell tracking mechanism, operative in accordance with a preferred embodiment of the present invention. In FIG. 12 the algorithm that tracks the cell capacity is based on analyzing the flow control messages over the Gb interface. The cell capacity for data, which changes dynamically and depends on the momentary voice traffic in the cell, is not given explicitly. Rather, the policy processor should use a “greedy” algorithm that increases the bit rate allocated to the users until it approaches congestions, and then backs off. The greedy mechanism illustrated in FIG. 12 tracks the cell capacity via a sequence of bit rate increment and decrement steps. Cell congestion is detected through flow control messages over the Gb interface. The size and frequency of the bit rate increment/decrement steps depends on the rate by which the dynamic capacity is changed.

Traffic shapers typically support enforcement of different resource settings per source IP address, which refers to the remote IP server on the down stream direction, per destination IP address, which refers to the mobile station, and per application packet flow type, such as e-mail, Web page, video stream, etc. Traffic shapers typically enforce maximum and average bit rate, delay and jitter, and maximum duration and maximum amount of data per flow. The traffic shaping may also include active radio interface resource management as well, such as radio link quality and radio channel coding schemes that affect the bit rate vs. bit error rate tradeoff.

There are three basic types of application packet flows to consider:

Real-time audio/video and audio/video streaming which require a virtual circuit delivering a certain constant or minimum bit rate throughout the session

Interactive services such as online gaming, M-commerce, and pulled e-mail, that do not require a constant bit rate, but that should tolerate a level of delay to enable interactivity

Non real-time services such as messages and pushed e-mail, where delay is of lesser concern.

For the purpose of supporting real-time applications, delay-sensitive applications and streaming applications, in order to ensure virtual circuits, the maximum number of concurrent flows per cell and/or per certain groups/types of flows should to be limited such that the required bit rate is below the bandwidth resources available for the cell. In this case, the policy processor may determine the maximum number of active streams per type of flow, and this limit is enforced by the traffic shaper.

Interactive service application flow types that need to be transmitted subject to certain delay constraints, require virtual circuits as well. However, only a certain average bit rate is required, rather than constant bit rate. The average bit rate may depend on the amount of data to be transferred, in order to ensure a certain delay. The considerations for resource allocation logic and limitations on the number of concurrent active flows are similar to those of the multimedia streaming cases above, with the exception that the type of resources are different (e.g., average bit rate rather than constant bit rate).

In non real-time services application flows that are less sensitive to data delivery time may still require virtual circuit functionality in terms of a certain delay and average bit rate. Other flows may require best-effort service only. Virtual circuits are managed by limiting the number of concurrent flows as explained above. It is the responsibility of the policy processor to allocate some virtual circuit to all the best-effort packet flows collectively, in order to avoid resource starvation and enable data delivery.

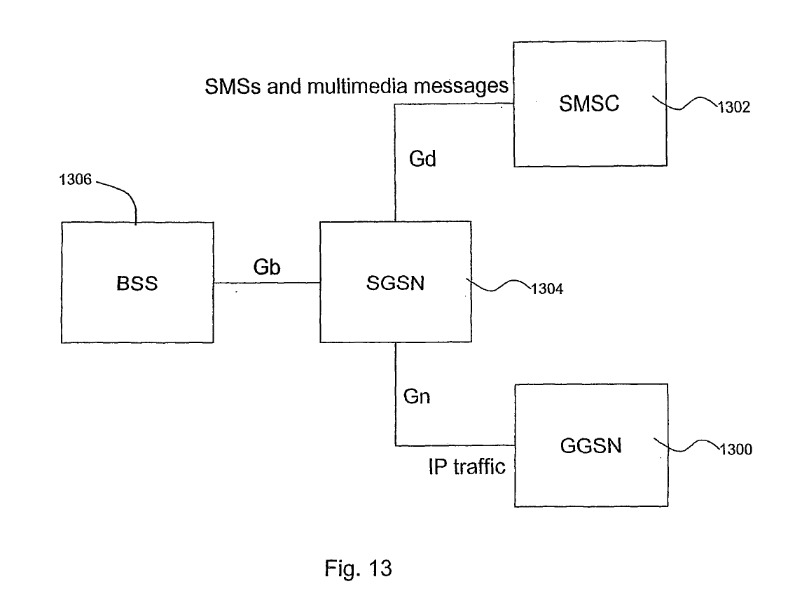

Reference is now made to FIG. 13, which is a simplified block diagram of an SMS gateway, constructed and operative in accordance with a preferred embodiment of the present invention. In addition to IP traffic or other packet-data traffic coming from GGSN gateways 1300, short messages and multimedia messages may be sent to the mobile user. These messages are typically sent from an SMSC 1302 and/or similar servers connected to a SGSN switch 1304 over a Gd interface, with SGSN switch 1304 interfacing with a BSS 1306. A policy processor as described hereinabove typically controls the SMSC 1302 output, ensuring that it does not create congestion over the air interface. This may be implemented using either of the following two approaches:

A dedicated control interface to the SMSC 1302 or to the SGSN 1304, where the SMSC 1302 acts as a store-and-forward server which is capable of delaying the messages.

An SMS traffic shaper located between SMSC 1302 and SGSN 1304 over the Gd interface.

Similarly, any data source that sends data over the air interface should be controlled by the policy processor of the present invention as part of the entire resource allocation policy.

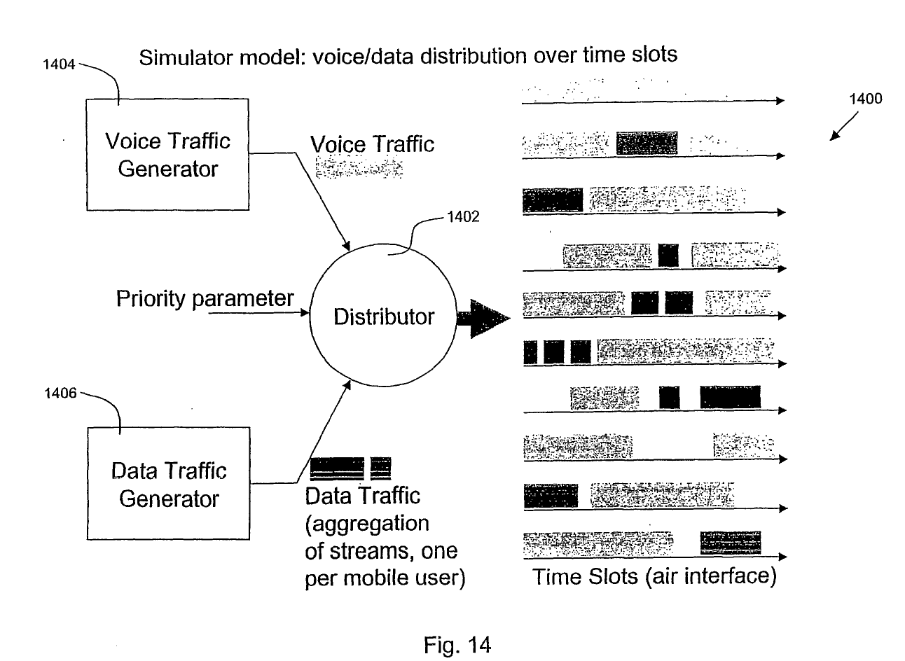

Reference is now made to FIG. 14, which is a simplified block diagram of a simulation of resource allocation, operative in accordance with a preferred embodiment of the present invention. The simulation of FIG. 14 is useful in evaluating the statistical properties of data traffic over a GPRS network by simulating downlink traffic. The simulation may be used for the following purposes:

Demonstration of the problem—rapid decline in service quality under certain load conditions

Prediction of expected network performance in terms of bandwidth, delay, and packet loss rate, as a function of the voice load and the data load over the network and the air interface in particular

Investigation of the effects of various parameters, such as intensity of usage of each application (e.g., e-mail, messages, video/audio streaming, etc.), on network performance

Supporting development efforts.

In FIG. 14 the air interface is modeled as N parallel resources equivalent to time slots 1400, where each resource carries a bit stream of bandwidth B. The N time slots represent the shared air interface resources in a single cell. For example, a four-carrier GSM/GPRS cell may contain 30 time slots available for voice and data traffic.

The simulation of FIG. 14 assumes a constant transport delay, a constant bit rate, and no loss over the air interface. Interference effects that translate into varying bit rate and delay, as well as bit errors, may be modeled as well. When considering radio interference, different transmission qualities may be associated with different time slots. This mechanism enables data traffic routing according to differentiated priorities, where certain traffic sources are prioritized via access to higher quality air links/time slots. In general, different link qualities result from different carriers/radio frequencies.

Voice traffic may be prioritized over data traffic, and vice versa. This is preferably controlled by a priority parameter P having a range of 0 to 1, where the voice priority is proportional to the parameter P value. P=1 indicates absolute priority for voice traffic, such that data traffic transmission is enabled only during voice pauses where a time slot is not busy carrying voice traffic. Different priorities may be allocated to different groups of time slots, e.g., N₁ time slots for data only (P=0) and N-N₁ slots for voice (P=1) where data is carried via any remaining resources.

FIG. 14 includes a distributor element 1402 which allocates voice and data traffic to free time slots based on a predefined distribution algorithm, such as round-robin, statistical, quality based, etc. If there is a demand for voice traffic to which resources cannot be supplied due to unavailability of free time slots, then the voice calls may be terminated immediately and a line-busy signal provided. Alternatively, data packets may be saved in a cell queue until time slots become available. The cell queue concept is explained below.

FIG. 14 also includes a voice traffic generator 1404 which generates voice calls according to common voice traffic distribution patterns (e.g., for 30 time slots, the voice traffic may represent approximately 20 Erlang units during a peak hour). Each voice call occupies a single time slot for the entire duration of its lifetime, which is typically random.

FIG. 14 also includes a data traffic generator 1406 which generates packet streams that represent traffic to be sent to the different mobile users. Distributor 1402 transmits one or more streams over between 1 and S time slots 1400 concurrently, based on availability of free time slots. Thus several data units that belong to stream(s) of one or more mobile users are transmitted simultaneously using more than a single slot. The transmission duration depends on the number of allocated time slots, the bit rate per time slot, and the amount of data that are to be transmitted. The number of time slots that serve a certain stream may be changed dynamically during its transmission period in the range of 0 to S, where 0 denotes a temporary interruption of this stream transmission, based on the need to transmit higher priority voice traffic or any other traffic.

In the simulation of FIG. 14 packets are read from the cell queue on a first-in-first-out basis. At later stages, different priorities may be associated with different streams that are stored in the cell queue. Different stream priorities may be expressed as a differentiation in bit rate, delay, jitter, radio link quality, hand-off priority, etc.

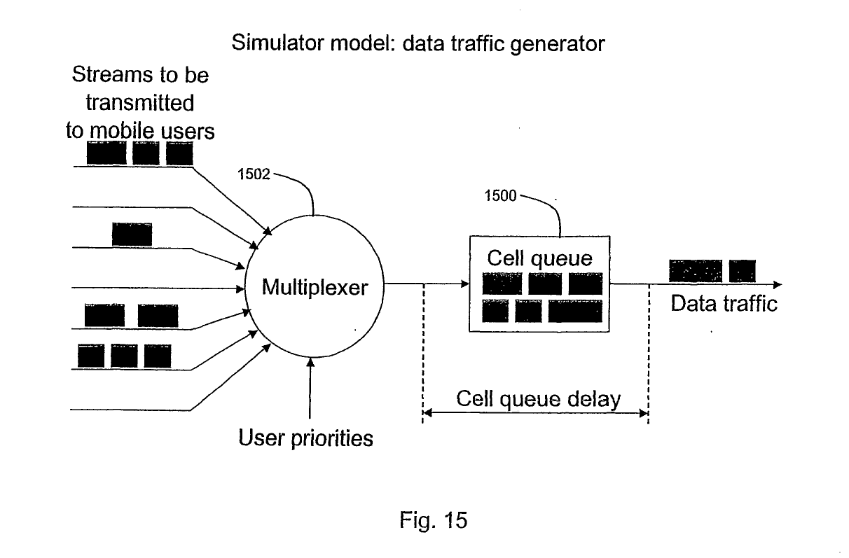

Reference is now made to FIG. 15, which is a simplified block diagram of a data traffic generator, constructed and operative in accordance with a preferred embodiment of the present invention. The data traffic generator of FIG. 15 includes a cell queue 1500 and a multiplexer 1502 which aggregates the traffic from the different streams that are generated for the different mobile users. Each data stream that arrives at multiplexer 1502 represents packet stream that should be transmitted to a certain mobile user on the downlink. Multiplexer 1502 aggregates the streams based on prioritization, which, in the case of SGSNs may be equal, as SGSNs do not currently support prioritization schemes.

Cell queue 1500 holds the aggregated stream. Packets are read from the queue on a first-in-first-out basis or on another queuing basis in order to accommodate different priority schemes. The queue is typically limited in size, such that when the queue is full, the packets that are sent from multiplexer 1502 to queue 1500 are discarded.

Cell queue 1500 simulates the combined queues of the base-station (PCU), the data switch (SGSN) and the gateway (GGSN). If the aggregated stream bit rate is less than the available capacity for data traffic over the air interface, i.e., the residual resources allocated for data over the time slots, then no delay is built up within cell queue 1500, and no packets are discarded. Alternatively, if the demanded bit rate is higher than the rate at which packets are read from cell queue 1500, then a delay is quickly created within queue 1500, and eventually packets are discarded. It is the responsibility of the policy manager and the traffic shaper as described hereinbelow to limit the bit rate of the aggregated stream below the cell data capacity, such that no delay is built up within cell queue 1500. Preferably, the policy manager of the present invention which controls the traffic shaper calculates the cell data capacity indirectly by dynamically adjusting the aggregated data stream bit rate such that no delay is accumulated in the BSS.

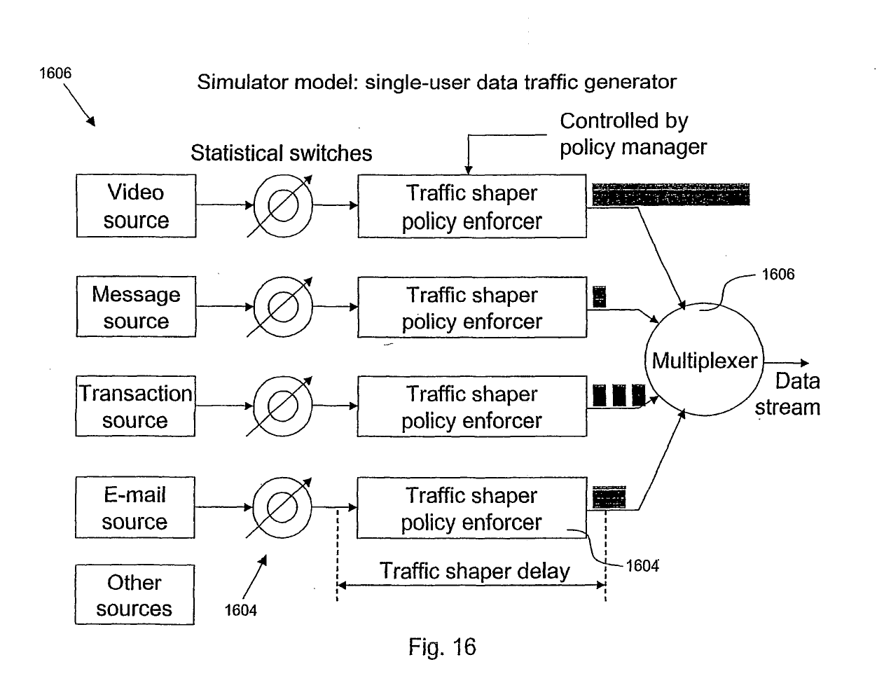

Reference is now made to FIG. 16, which is a simplified block diagram of a single-user data traffic generator model, constructed and operative in accordance with a preferred embodiment of the present invention. FIG. 16 shows the statistical process of generating data traffic (i.e., a packet stream) for each mobile user. Each stream is an aggregation of data flows, where each flow represents a packet sequence that carries the content of a certain application. In FIG. 16 each mobile user is represented by several data sources 1600, one per available application, where the aggregation of their outputs creates the downlink data stream of the user.

The data stream of FIG. 16 is created as follows. Each data source 1600 creates a flow (i.e., a sequence of packets) according to the statistical properties of the application represented by the source. For example, a video source may produce a sequence of equal-size packets that create a constant bit rate (e.g., 30 Kbps), of random duration. An E-mail source may produce a sequence that consists of relatively few packets, containing random amounts of data. Statistical switches 1602 represent the intensity of each data source 1600. Each switch 1602 is activated at random, where every activation creates a single flow to be emitted from a data source 1600. The activation rate is typically predefined.

Traffic shapers 1604 are responsible for enforcement of the QoS policy on each flow, in terms of bit rate, delay, duration, and amount of data. The flow packets are stored and delayed in the queue of its traffic shaper 1604, such that the output flow from the queue meets the required QoS parameters. The different flows are aggregated by a multiplexer 1606 into a data stream that is sent through the cell queue over the air interface to the corresponding mobile user.

It is the responsibility of the policy manager to determine the QoS policy and allocate the QoS rules for every stream of every mobile user, such that the overall aggregated stream per cell does not create overflow on the cell queue.

In the simulators of FIGS. 14, 15, and 16 the policy manager of the present invention is not modeled. Therefore, the simulators of FIGS. 14, 15, and 16 may be used to demonstrate the deterioration in quality as a function of the cell load. Thus no QoS enforcement is applied, and the traffic shaper is transparent. The only limitation on traffic will be created by the air interface/time slots. Once they are overused, delay will accumulate in the cell queue, and packets will be discarded.

The user of the simulator may change parameters such as:

Cell size (number of time slots)

The voice traffic (given in Erlang units) and its precedence parameter over data, including number of time slots allocated for data only

The number of concurrent data users in each priority group

Statistical parameters of the data sources per priority group, including the flow's activation rate

Maximum number of concurrent time slots per mobile station

The size of the cell queue (in seconds or bytes), above which packets are discarded.

In this manner the simulator user may create a simulated environment of the load on the air interface in the cell. The simulation represents the voice traffic load (in Erlang units), and the data load of a certain number of data users where each one requires various data applications according to certain statistical profile. The mobile users are divided into several different priority groups (e.g., consumer vs. business subscribers), such that the statistical properties of the data usage are individually configured for each group.

In order to evaluate transmission quality, a specific application flow may be tracked within the cell queue. The behavior of the flow, in terms of throughput (bandwidth), delay and packet loss may be evaluated as a function of the above mentioned parameters. An inconsistent transmission quality of multimedia flows or unreasonably large delay of messages and transactions may be seen under certain network load conditions.

The simulators of FIGS. 14, 15, and 16, may be configured to take packet loss effects into account, including bit errors over the air interface and discarded packets in full queues. The simulations may include a retransmission mechanism, as retransmission may negatively impact performance by reducing the net bit rate of certain streams that have already lost some packets due to insufficient bandwidth resources.

Various extensions of the present invention are now described. Future radio and base station equipment may provide interfaces for certain dynamic radio resource control, such as:

Allocation of certain radio channels characterized by different transmission qualities to certain data units, including transmission qualities in terms of signal to noise ratio, fading parameters, frequency hopping, transmission power, etc.

Allocation of certain channel-coding schemes to certain data units.

A dynamic resource management solution may utilize these interfaces and capabilities to control the radio resources and to achieve higher quality and better utilization of the air interface. Air interface resources and capabilities may be allocated based on the knowledge of the current demand for different types of applications at different priority levels. Based on the demand and the resource availability, the dynamic resource management solution may efficiently allocate air-interface/radio resources to different packet flows.

Examples of efficient allocation include certain radio links which provide a consistent bit rate and low delay and which may be allocated to virtual circuits supporting multimedia streaming. Alternatively, radio links which provide low frame erasure probability but inconsistent bit rate may be allocated to e-mail type TCP/IP traffic.

Future mobile networks may support several radio connections from one mobile station to a few cells or base stations simultaneously. These multiple connections may be utilized such that each different application flow is routed over different links according to the application requirements, such as bit rate, delay, error rate, priority, etc. Alternatively, the same application flow may be transmitted simultaneously on multiple radio connections to ensure a very high probability of data delivery over the air on time. In this case, duplicated packets arriving from different connections are omitted on the mobile station side, while the probability of a data packet being lost is reduced due to simultaneous transmission over more than a single radio connection.

Service quality may also be supported while the mobile user is roaming (i.e. connected over a mobile network other than his/her home network). Using inter-carrier and inter-network protocols, a level of service quality may be provided over the visited network based on the mobile user profile as stored in the home network, given the current policy and resources in the visited network.

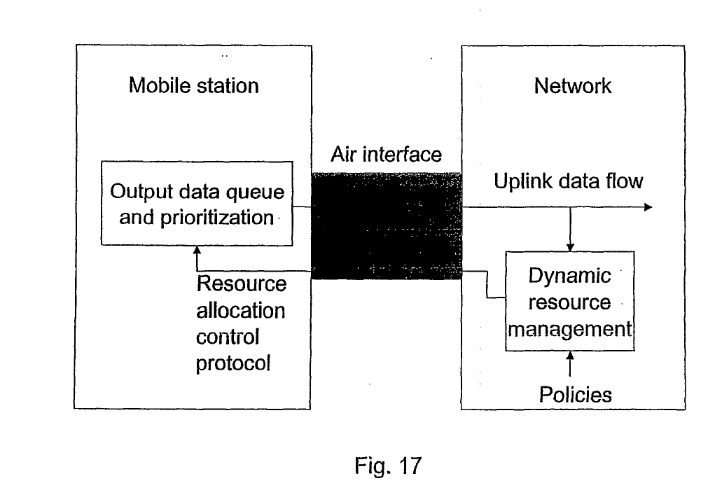

While the present invention concentrates on resource management in the downlink direction. In the future, using certain resource allocation protocols over the air interface, the present invention may control the uplink data flow from the mobile station as illustrated in FIG. 17.

While the present invention discloses real-time traffic shaping with queuing of individual application packet flows, a store-and-forward database may be implemented where certain messages and data streams are stored for longer periods and transmitted to the mobile users when the network is not overloaded. The policy processor than manages traffic shapers and store-and-forward servers together. Certain packet flows are stored in the store-and-forward server and are released for transmission on the air interface at a later time according to certain policies and dynamic resource control.

The present invention in general, and the simulators of FIGS. 14, 15, and 16 that are based on real-time inputs in particular, may be used for the following purposes:

Decision support (e.g., network extensions, new service provisioning)

Quality of service tuning

Network planning (e.g., network dimensioning and new equipment setup to support service quality and new applications).

Based on statistical data collected during live operation of the present invention, and based on simulation supported by this data, various service scenarios may be investigated before making decisions of actual deployment and the scale of deployment of new equipment or new network configuration. The statistical data is also valuable as a source for analyzing bottleneck points within the network, based on real-life data and usage. Online statistical data may be used for dynamic allocation of resources between cells.

The present invention may be used to provide valuable real-time information to mobile users such as:

the user's location

the user's resource usage profile (e.g., which applications, data volume, usage intensity, etc.)

the user's handset capabilities.

This information may be used through APIs to 3rd party solutions for various applications and services, for data mining, for advanced billing, and other applications.

The present invention may provide the basis for pre-paid applications. The dynamic resource control mechanism of the present invention may be used to enforce service cut-off upon reaching a certain usage amount. Limits may also be enforced according to usage per type of data/application, per mobile user, per application service provider, etc. Such limits may be enforced differently at different dates and times.

In addition to the IP side as seen through the GGSN, other information sources may be utilized by the present invention and controlled by the policy processors, either directly through dedicated interfaces or indirectly via proxy servers such as traffic shapers. For example, SMSC servers and multimedia messaging servers may be controlled by the present invention to regulate the flow of information from these servers and enforce policy rules.

It is appreciated that one or more of the steps of any of the methods described herein may be omitted or carried out in a different order than that shown, without departing from the true spirit and scope of the invention.

While the methods and apparatus disclosed herein may or may not have been described with reference to specific hardware or software, it is appreciated that the methods and apparatus described herein may be readily implemented in hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

1. A resource allocation system for a network, the system comprising:
a traffic shaper operative to decompose a network stream into a plurality of flows, each flow representing a service or application on a network, and shape traffic on said network by allocating a different bandwidth and delay to each flow; and
a policy processor operative to control said traffic shaper and dynamically allocate at least one air interface resource to at least one network device in association with at least one of said flows.

2. A system according to claim 1, wherein said policy processor is operative to retrieve information regarding a mobile user.

3. A system according to claim 2, wherein said information includes any of a user profile and a user location.

4. A system according to claim 1, wherein said policy processor is operative to retrieve information regarding said network.

5. A system according to claim 4, wherein said information includes any of an ASP profile and a measure of loading on said air interface.

6. A system according to claim 2, wherein said policy processor is operative to issue a service quality control signal associated with any of said information to said traffic shaper.

7. A system according to claim 2, wherein said policy processor is operative to interface with a mobile telecommunications system infrastructure and retrieve any of said information.

8. A system according to claim 1, and further comprising:
administration means for provisioning said system, defining policies for said policy processor, and monitoring system operations.

9. A system according to claim 1, wherein said network is a cellular telephone network.

10. A system according to claim 9, wherein said policy processor comprises:
a capacity and mobility analyzer operative to:
track the distribution of a plurality of mobile stations among a plurality of cells of said network; and
determine load and available resources available to said air interface; and
a core policy processor operative to budget any of bit rate, delay, duration, and amount of data for any of said cells such that said bit rate for any of said cells does not exceed a dynamic capacity which is available for data transmission in said cell.

11. A system according to claim 1, wherein said traffic shaper is intermediate a GGSN and an IP packet network.

12. A system according to claim 1, wherein said policy processor is intermediate said traffic shaper and an SGSN.

13. A method for allocating resources in a network comprising:
decomposing a network stream into a plurality of flows;
shaping traffic on said network by allocating at least one resource to each flow of said plurality of flows; and
controlling said at least one allocated resource for at least one flow of said plurality of flows by dynamically adjusting said at least one allocated resource for at least one air interface that is associated with at least one network device.

14. The method according to claim 13, wherein each flow of said plurality of flows represents a service or application on a network down-link.

15. The method according to claim 13, wherein said network is a cellular telephone network.

16. The method according to claim 13, wherein said at least one resource includes at least one of bandwidth or delay.

17. The method according to claim 13, wherein said dynamically adjusting said at least one allocated resource is in accordance with policies for said network.

18. An architecture for allocating resources in a network comprising:
a first component configured for decomposing a network stream into a plurality of flows;
a second component configured for shaping traffic on said network by allocating at least one resource to each flow of said plurality of flows; and
a third component configured for controlling said at least one allocated resource for at least one flow of said plurality of flows by dynamically adjusting said at least one allocated resource for at least one air interface that is associated with at least one network device.

19. The architecture according to claim 18, wherein said first component and said second component are included in a traffic shaper.

20. The architecture according to claim 18, wherein said third component is included in a policy processor.

21. The architecture according to claim 18, wherein said network is a cellular telephone network.

22. The architecture according to claim 18, wherein said at least one resource includes at least one of bandwidth or delay.

23. The architecture according to claim 18, additionally comprising, a fourth component configured for provisioning said network, defining policies for said third component for controlling said at least one allocated resource, and monitoring operations of said network.

24. The architecture according to claim 23, wherein said fourth component is included in an administration unit.

25. A programmable storage device readable by a machine, tangibly embodying a program of instructions executable by a machine to perform method steps for allocating resources in a network, said method steps selectively executed during the time when said program of instructions is executed on said machine, comprising:
decomposing a network stream into a plurality of flows;
shaping traffic on said network by allocating at least one resource to each flow of said plurality of flows; and
controlling said at least one allocated resource for at least one flow of said plurality of flows by dynamically adjusting said at least one allocated resource for at least one air interface that is associated with at least one network device.

26. The storage device according to claim 25, wherein each flow of said plurality of flows represents a service or application on a network down-link.

27. The storage device according to claim 25, wherein said network is a cellular telephone network.

28. The storage device according to claim 25, wherein said at least one resource includes at least one of bandwidth or delay.

29. The storage device according to claim 25, wherein said dynamically adjusting said at least one allocated resource is in accordance with policies for said network.
